(19) United States
(12) Patent Application Publication
(10) Pub. No.: US 2001/0016859 A1
(43) Pub. Date: Aug. 23, 2001

(54) Document handling apparatus for editing document file data and computer readable medium including document handling program

(76) Inventors: Takamichi Sekido, Tokyo (JP); Shinichi Mori, Gifu-ken (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(21) Appl. No.: 09/766,270

(22) Filed: Jan. 19, 2001

(30) Foreign Application Priority Data
Jan. 25, 2000 (JP) 15906/2000

(51) Int. Cl. G06F 15/00

(52) U.S. Cl. 707/530

(57) ABSTRACT

The invention is intended to enable page division or page unification of a document file with a good operating efficiency. To this end, a plurality of icons or thumbnails each representing an imaged document files are displayed in an arrayed form on a list window area on which the document files having a plurality of pages can be arrayed. Then, the icon or thumbnail of a prescribed document file selected among the icons or thumbnails of the plurality of the document files is arrayed on the list window area is transferred to a pallet window area, thereby to page-divide or page-unify the document file whose icon or thumbnail has been transferred.

### BACKGROUND OF THE INVENTION

1. Field of the Invention

The present invention relates to a document handling that includes various kinds of operations for handling a document file. More particularly, the invention relates to an improvement in each of a method, apparatus, and program that enable high-efficient performance of page division (page-by-page separating) and page unification (lumping of document files or page files) of the document file.

2. Description of the Prior Art

As the document-handling software (hereinafter referred to as “a handling software”) is known a software that not only manages a document file but also enables performing various kinds of operations such as page division (page-by-page separating) and page unification (lumping of document files or page files) of the document file.

In executing such page division or page unification of a document file with use of such a conventional handling software, operation has hitherto been carried out on a list window area that enables document files each having a plurality of pages to be lined up.

That is to say, when executing the page division or the page unification of a document file with use of the conventional handling software, the operation of the page division or the page unification has hitherto been carried out on the list window area that enables document files each having a plurality of pages to be lined up. Therefore, it results that document files associated with the operation of such page division and page unification and other document files not associated with the operation of such page division and page unification exist together on the same image screen. This causes a bad operating efficiency.

It is to be noted that some of conventional pieces of handling software have a format specific thereto with regard to a document file that has been registered. A document file of the above-mentioned specific format is produced from the original document file, whereby, using this specific-format document file, managing and handling of the original document file are performed.

For the above-described reason, concerning data of a document file which has been handled using such handling software, it cannot be confirmed without this handling software how the document file is. Accordingly, in case that the document file that has been handled with the handling software is handed to a third party, the handling software itself as well must be handed to together with the document file.

The document file of specific format and the document file of original format are associated with each other in an initial state. However, when the specific-format document file is subject to page division using the handling software, a top page of the specific-format document file as page divided is in associated relationship with the original-format document file while the relationship between second and succeeding pages of the document file as page divided and the original-format document file is dissociated from each other. Resultantly, the operation such as returning the document file once page divided to its original state or unifying of those divided pages.

### SUMMARY OF THE INVENTION

The present invention has been made to solve the above-described problems and it is a first object of the invention to realize operation of page division of a document file or page unification of the file as page divided with an excellent operating efficiency.

It is a second object of the invention to keep relationship between the original-format document file and the document file with pages divided without adversely affecting the original-format document file.

It is a third object of the invention to enable confirming the result of the document file that has been handled using a handling software, even in an operational environment having no such handling software therein.

To attain the above objects, the present invention provides the followings.

According to a first aspect of the invention, a document handling apparatus for handling a document file comprises a list window area enabling a plurality of document files to be arrayed thereon, a pallet window area enabling the document files arrayed on the list window area to be transferred thereto and enabling operation of page division or page unification of the document file whose icon or thumbnail has been transferred; and document file operation means for executing page division or page unification of the document file on the pallet window area.

According to a second aspect of the invention, a recording medium including a document handling program for handling a document file includes a process for displaying in an arrayed form a plurality of document files on a list window area on which a plurality of document files can be arrayed; and a process for transferring an icon or thumbnail of the prescribed document file selected from among the icons or thumbnails of the plurality of the document files arrayed on the list window area, to a pallet window area, thereby to execute page division or page unification of the document file corresponding to the transferred icon or thumbnail.

According to a third aspect of the invention, a document handling method for handling a document file comprises displaying in an arrayed form a plurality of icons or thumbnails each representing an imaged document files on a list window area on which a plurality of document files can be arrayed; and transferring an icon or thumbnail of a prescribed document file selected among the icons or thumbnails of the plurality of the document files arrayed on the list window area, to a pallet window area, thereby to perform page division or page unification of the document file corresponding to the transferred icon or thumbnail.

In these aspects of the invention, a plurality of icons or thumbnails each representing an imaged document file are displayed in an arrayed form on a list window area on which a plurality of document files can be arrayed and an icon or thumbnail of a prescribed document file selected among the icons or thumbnails of the plurality of the document files arrayed on the list window area is transferred to a pallet window area, thereby to execute page division or page unification of the document file corresponding to the transferred icon or thumbnail.

As a result, it becomes unnecessary to perform the operation such as page division or page unification on the list window area on which other document files having no relevance to such operation as page division or page unification co-exist. Namely, it becomes possible to execute the page division or page unification of a desired document file with a good operating efficiency.

In case that handling such as page division or page unification has finished, it is preferable to return the document file which has been subject to such page division or page unification from the pallet window area to the list window area.

It is also preferable that, on the pallet window area, outputting of the document file can be instructed using the icon or thumbnail thereof.

It is also preferable that, on the pallet window area, inputting of the document file ban be performed.

According to further aspect of the invention, a document handling apparatus for editing document file data comprises document file importing means for importing first document file; document file creating means for creating second document file by converting first document file in a predetermined format; editing means for executing a page division process and/or a page editing process for document files, wherein said editing means creates third document file duplicated from said second document file, and execute the page division process and/or the page editing process on the basis of said third document file; and document relational means for relating said first document file with said second document file and for relating said second document file with third document file.

According to further aspect of the invention, a recording medium including a document handling program includes a process for creating a general-purpose format document file on the basis of a document file as input, a process for handling the general-purpose format document file thus created and the document file whose format bas been input in associated relationship with each other; and a process for copying the general-purpose format document file and page dividing the document file thus copied.

According to further aspect of the invention, a document handling method for handling a document file comprises creating a general-purpose format document file on the basis of a document file as input; handling the general-purpose format document file thus created and the document file whose format has been input in associated relationship with each other; and copying the general-purpose format document file and page dividing the document file thus copied.

In these aspects of the invention, a general-purpose format document file is created on the basis of a document file as input, the general-purpose format document file thus created and the document file whose format has been input are handled in associated relationship with each other, and when page dividing the document file, the general-purpose format document file is copied and the document file thus copied is page-divided.

As a result, even when the document file has been page-divided, the associated relationship between the general-purpose document file and the original-format document file is maintained with the result that there will be no adverse effect upon the original-format document file. Therefore, matching between both document files is kept.

According to further aspect of the invention, document handling apparatus for editing document file data comprises document file importing means, wherein said importing means creates new document file having a predetermined format on the basis of an import of an original document file; and document file relating means for relating said created new document file with said original document file.

According to further aspect of the invention, a recording medium including a document handling program includes a process for creating a general-purpose format document file on the basis of a document file as input and a process for handling the general-purpose format document file thus created and the document file whose format has been input in associated relationship with each other.

According to further aspect of the invention, a document handling method comprises creating a general-purpose format document file on the basis of a document file thus input and handling the general-purpose format document file thus created and the document file whose format has been input in associated relationship with each other.

In each of the above-described aspects of the invention, a general-purpose format document file is created on the basis of an input document file and the general-purpose format document thus created is handled in association with the document file of an input format that has been input.

The term “general-purpose document file” means one whose layout can be kept in display on an image screen or in printed form regardless of PC environment, models of printers, etc. and in which reading and inspection software is easy to get. It is to be noted that, further preferably, such a reading/inspection software is available free of charge. An example of the “general-purpose document file” is a document file whose format is called “a PDF (Portable Document Format)” that is available at Adobe Systems Incorporated.

“Handling the document files in associated relationship with each other” means to handle document files as having mutual association with each other wherein filenames other than extension parts thereof coincide with each other, or to manage the places of respective document files (e.g. store these respective document files into the same folder or directory), etc.

As a result, it will be possible to confirm the state of the document files as handled even in such environment that there is no handling software associated with the document files (i.e. such handling software is not installed), by obtaining a reading/inspection software (for example “Acrobat Reader” (trade mark) of Adobe Systems Incorporated for PDF file) with which it is feasible to read/inspect the document files of a general-purpose format.

### BRIEF DESCRIPTION OF THE DRAWINGS

FIG. 1 is a block diagram showing the connection of an apparatus according to an embodiment of the present invention;

FIG. 2A is a pictorial view showing an example of display of a list window area according to the embodiment of the present invention;

FIG. 2B is a pictorial view showing an example of a pallet window area that has been opened on the list window area;

FIG. 3 is a flow chart showing an operation according to the embodiment of the present invention;

FIG. 4A is a pictorial view showing an example of the pallet window area that has been opened on the list window area according to the embodiment of the present invention;

FIG. 4B is a pictorial view showing the document file shown in FIG. 4A with page divided.

FIG. 5 shows a procedure of importing a document file from a list window area to a palette window; and,

FIG. 6 shows a procedure of page division of a document file on the palette window.

### DETAILED DESCRIPTION OF THE PREFRRED EMBODIMENTS

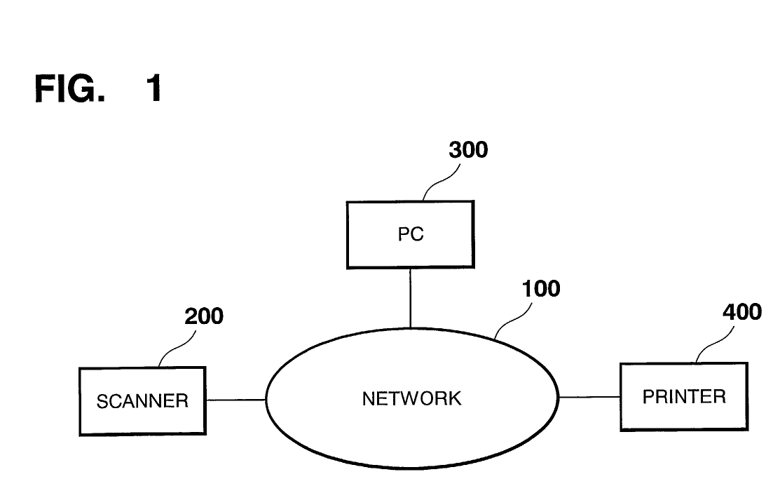

FIG. 1 is a block diagram showing a document handling apparatus according to an embodiment of the present invention and connection in the vicinity thereof. It is to be noted that in FIG. 1 description is focussed mainly upon the functions necessary for explaining the operation of this embodiment and therefore illustration of detailed hardware constructions is omitted.

In FIG. 1, reference numeral 100 denotes a network such as a LAN, Inter-net and Intra-net, reference numeral 200 denotes a scanner that serves as a reader to enable input of an image or a document, and reference numeral 300 denotes a personal computer (PC) that operates as a document handling apparatus that constitutes a characterizing part of this embodiment. The personal computer 300 here is a general computer which includes a memory as a computer readable medium and a display and in which a document handling program operates.

The document handling program as below mentioned is usually stored in the memory of the personal computer, but can be executed on a memory mounted on other computer on a network. The document files referred to in the present invention can be stored not only in the memory of the personal computer, but also in memories of the other computers on the network, so that the document handling program as above mentioned can operate with data corresponding to document files stored on those memories. It is to be noted that the document handling program can be installed in terminals with computer readable medium such as CD-ROM or the like, but can be loaded down through the network. Reference numeral 400 denotes a printer that serves as an apparatus to output a hard copy of an image or a document.

A composite machine (an image forming apparatus, a scanner, etc.) consisting of the scanner 200 and the printer 400 in an integrated form also exists and may be used in the invention.

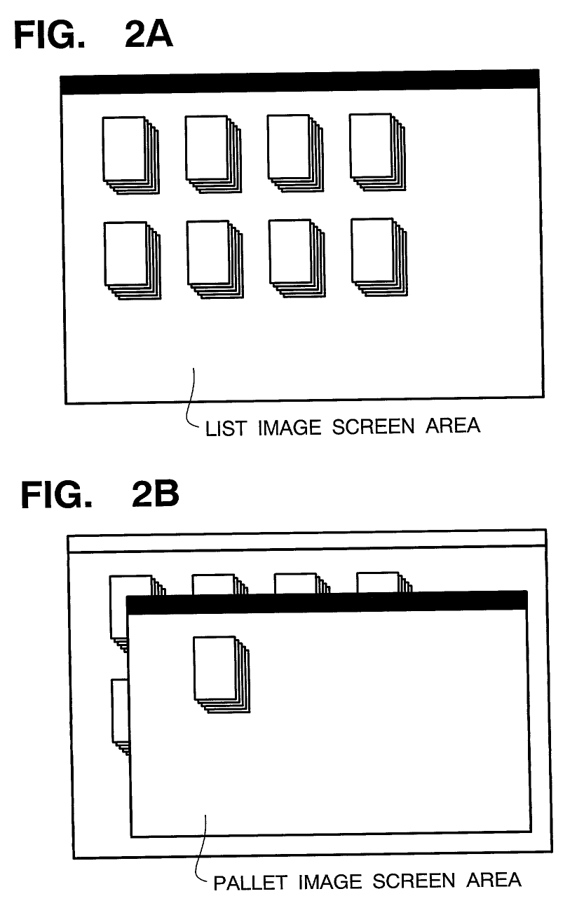

FIG. 2A pictorially illustrates an example of display of a list window area under operation of the document handling program, and FIG. 2B pictorially illustrates an example of display of a pallet window area that under operation of the document handling program which is opened on the list window area.

On the list window area can be arrayed a plurality of icons or thumbnail of document files. In FIG. 2A, eight icons or thumbnails of document files each having a plurality of pages are lined up in an operable state.

The icons or thumbnails of the document files lined up on the list window area can be transferred to the pallet window area by the operation of drug & drop. Page division or page unification can be performed with respect to each of the document files whose icons or thumbnails have been transferred thereto. FIG. 2B illustrates a state where one piece of document files has been transferred from the list window area to the pallet window area. This pallet window area is another window area that pops up from the list window area.

Here, the icon or thumbnail of the document file is intended to display the existence of the document file by an image. Although the icon may even be a general icon, the thumbnail is preferred. Namely, in the list window area or the pallet window area, the existence of the document files is indicated by display of corresponding icons or thumbnails.

Incidentally, in this embodiment, it is characterized that a document file having a general-purpose format is created according to an input document file, when handling the document files, and the document file of general-purpose thus created and the document file of an input format as input are handled in association with each other.

The term “general-purpose document file” means one whose layout can be kept in display on image screen or print-out regardless of PC environment, models of printers, etc. and in which reading and inspection software is easy to get. An example of “the general-purpose document file”, is a document file whose format is called “a PDF (Portable Document Format)” that is available at Adobe Systems Incorporated.

Accordingly, in the specification of this application, the document files whose format is specific to each of various kinds of word processors are referred to simply as “the document files”. It is to be noted that an image file whose format is TIFF or BMP is also handled as a document file.

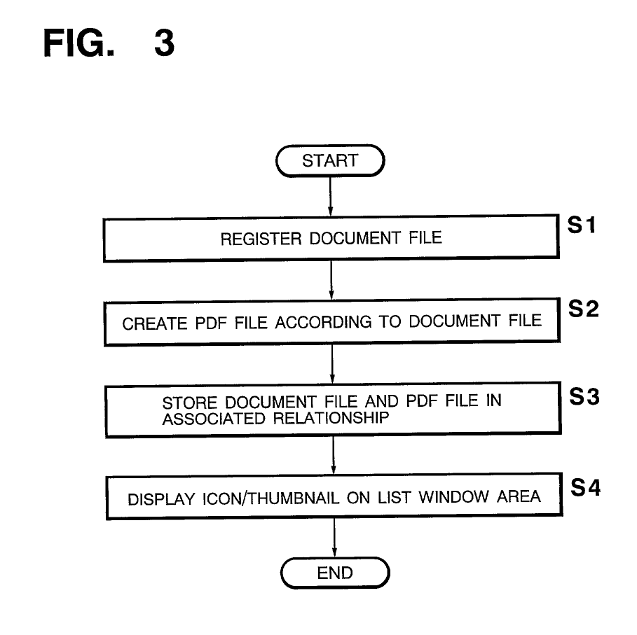

Explanation will now be made with reference to FIG. 3 on the PDF file as an example of the document file of the general-purpose format created from a document file. It is to be noted, however, that the general-purpose format of document file is not limited to this PDF file.

First, in a document handling program, a desired document file is registered into the list window area (step S1). If there are any document files already registered into the document handling program, icons or thumbnails of the document files are displayed in the list window area.

When a new document file is registered into the document handling program, a general-purpose format document-file formation means (or Acrobat (tradename) of Adobe Systems Incorporated) creates a PDF file on the basis of that new document file under the document handling program (step S2).

In the document handling program, document-handling means stores the input original format document file and the general-purpose format document file (here the PDF file) into a prescribed folder (directory) in associated relationship with each other (step S3).

In connection with this, there may be a method wherein the document handling program detects coincidence of the portions of respective filenames that are other than the extension parts thereof and handles the files whose filenames have coincidence in associated relationship with each other.

Other than this, each time a new document file is registered, a new folder may be created, whereby the input original-format document file and the general-purpose format document file are stored into the same folder and may be handled in associated relationship with each other in the document handling program.

Incidentally, other than managing both document files by their filenames or storing them into the same folder or directory, it is also possible to handle these document files in associated relationship with each other by managing places of the respective document files.

This embodiment is characterized in that icons or thumbnails each representing a piece of imaged document files are displayed as shown in FIG. 2A on a list window area (step S4). Then the icon or thumbnail of a prescribed document file selected from the icons or thumbnails of a plurality of the document files displayed on the list window area is transferred to or imported into a pallet window area as shown in FIG. 2B. Thereby, page division or page unification of the document files corresponding to the imported icon or thumbnail is executed.

A list of the document files to be handled according to the above-described registration of document files is displayed on the list window area of FIG. 2A. In FIG. 2A, eight pieces of document files are in a state to be handled.

First, a desired one of the icons or thumbnails of the document files lined up on the list window area is imported into the pallet window area by operation of drug & drop, etc. (FIG. 2B). In FIG. 2B, although only one piece of document file is imported into the pallet window area, a plurality of pieces of document files may also be imported.

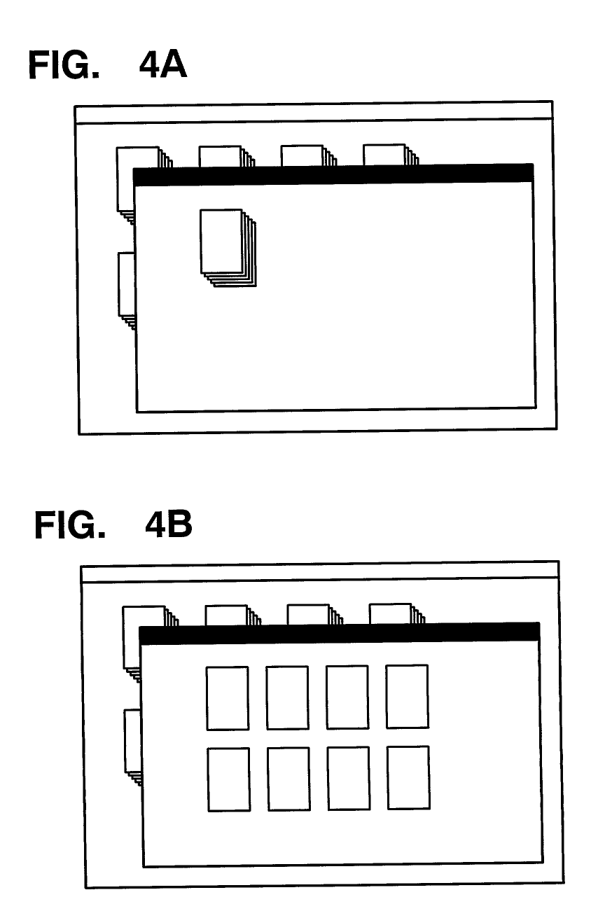

Regarding the document file whose corresponding icon or thumbnail has been imported into the pallet window area, the processing program executes page dividing, or page unifying operation according to the operator's instructions. For example, by executing page division of the document file that exists on the pallet window area as in FIG. 4A, the document file can be divided into page files having each page displayed as shown in FIG. 4B. FIG. 4B illustrates an example of the document file including eight pages in total.

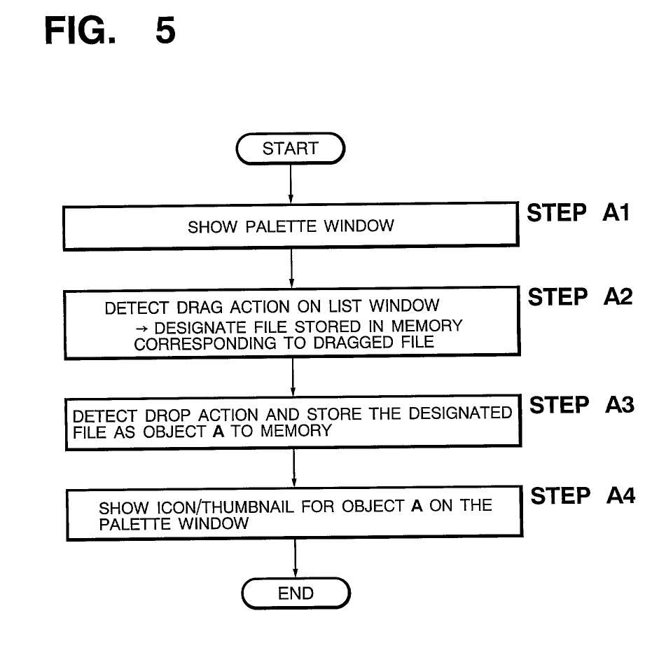

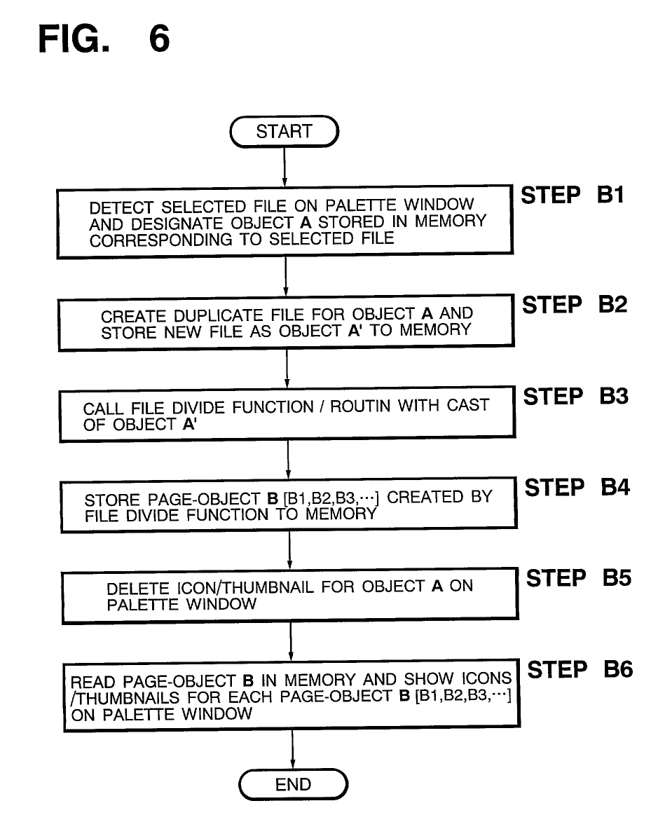

FIG. 5 shows a procedure of importing a document file from a list window area to a palette window and FIG. 6 shows a procedure of page division of a document file on the palette window.

The procedure to achieve file operations of this invention is not limited to these procedures.

The page files can be unified into a document file by designating and unifying the icons or thumbnails corresponding to desired ones of the page files shown in FIG. 4B. It is also possible to perform page division of each of a plurality of the document files into page files and to perform unification of desired ones of these page files that have been selected from them into a document file.

It the foregoing, page division and page unification have been shown as the example of handling a document file. It is also possible to execute processing such as rotation processing of a document file or page file. In this case as well, the processing program executes processing of the document file or page file according to the instructions given to the icon or thumbnail.

It is also preferable to enable on the pallet window area the operation of inputting (registration) the document file from a given folder within a magnetic disk of the scanner 200 or PC 300 and the operation of inputting the document file that has been received by a facsimile or e-mail, etc. In these cases, registration of the document file is performed using the process steps shown in FIG. 3.

Further, it is also possible to designate on the pallet window area the icon or thumbnail of the document file or page file to perform print outputting from the printer 400, and perform facsimile transmission, e-mail transmission, etc.

Incidentally, when having completed the handling operation such as page division or page unification on the pallet window area, the document file or page file that has undergone the page division or page unification is returned from the pallet window area to the list window area by the operation of drug & drop.

As has been described above, according to this embodiment, the icon or thumbnail of a prescribed document file selected from the icons or thumbnails of a plurality of the document files lined up on the list window area is imported into the pallet window area. By page division or page unification of the document file whose icon or thumbnail has been transferred, it becomes unnecessary to perform the operation such as page division or page unification in the list window area on that other document files having no relevancy to the page division or page unification exist. Namely, it becomes possible to perform the operation such as page division or page unification of a desired document file on the pallet window area where only relevant document files exist, with a good operating efficiency.

Further, when attempting to read the output file (a pair of files of the original-format document file and the PDF file) obtained by the above-described document-file handling (the document handling such as page division or page unification) by a computer with its operational environment having no handling software of a document file or a computer in which no such software is installed, it becomes possible to read and confirm that output file by getting a reading software enabling reading and inspecting a general-purpose document file (in the case of the PDF file the Acrobat Reader (tradename) of Adobe Systems Incorporated. For this reason, compared with the conventional technique where the format specific to the document-handling software (the document handling program) is used, the embodiment provides broader applicability.

The present embodiment is characterized in that, when performing the page division of the document file as explained above, the general-purpose format document file (the PDF file) is copied and the copied document file (the PDF file for use for page dividing) is page-divided.

Namely, as already explained, in this embodiment, document-handling means of the document handling program stores the original-format document file as input and the general-purpose format document file (here the PDF file) into a prescribed folder (directory) in associated relation with each other. Then, when the operator gives instructs to execute page division, the document-file processing means of the document handling program reproduces the PDF file thereby to create the PDF file for use for page division. It is to be noted here that the PDF file that is stored in paired relationship with the original-format document file is left without being subject to any correction. Then, document-file processing means of the document-file handling program executes page division of the duplicated and created PDF file for page division.

As a result, even if the page division of the document file has been executed, the relationship between the general-purpose format document file and the original-format document file is kept and no effect is affected to the original-format document file, so that matching condition is maintained. Also, even when canceling the state where the document file has been once page divided, the page divided files can be immediately returned to the original state.

In the first aspect of the invention, icons or thumbnails representing a plurality of document files as imaged are displayed on a list window area on which the plurality of the document files can be displayed. Then, the icon or thumbnail of a prescribed document file selected among the icons or thumbnails for a plurality of the document files lined up on the list window area is imported into a pallet window area and page division or page unification is performed on the document file whose icon or thumbnail has been transferred. As a result, it becomes unnecessary to perform the operation of page division or page unification in the list window area on that other document files having no relevancy to the page division or page unification exist. Namely, it becomes possible to perform the operation such as page division or page unification of desired document files on the pallet window area where only relevant document files exist with a good operating efficiency.

In the second aspect of the invention, a general-purpose format document file is created on the basis of a document file as input, and the general-purpose format document file thus created and the document file of the format as input are handled in association with each other. Therefore when page division is performed on the document file, the general-purpose format document file is duplicated and the document file thus duplicated is page divided. As a result, even if the document file has been page divided, the mutual association between the general-purpose format document file and the document file of the original format is kept, no adverse effect is affected on the original-format document file. Thus, it becomes possible to simply execute the operation such as returning the document file once page divided to its original state or unifying them.

In the third aspect of the invention, a general-purpose format document file is created on the basis of a document file as input and the general-purpose format document file thus created and the document file of the format as input are handled in association with each other. Therefore, even in the operational environment having no relevant document-file handling software, it becomes possible to read and confirm the state of the document file as handled by obtaining reading software with which a general-purpose document file can be read and inspected.

What is claimed is:

1. A document handling apparatus for editing document file data, comprising;
window display means for displaying a list window area for lining up a plurality of icons/thumbnails for document files and a palette window area for editing the document file, said palette window area being enable to import document file shown in said list window area and to show icons/thumbnails corresponding to the document file imported; and
file operation means for executing a page division process or a page unification process of document file on the basis of an operation for the icon/thumbnails shown on said palette window area.

2. The document handling apparatus of claim 1, further comprising a display device, wherein said window display means displays said list window area and said palette window area through said display device.

3. The document handling apparatus of claim 1, wherein each document file is corresponding to file data stored in a memory, and said file operating means operates each document file on the basis of the file data in the memory.

4. The document handling apparatus of claim 1, wherein said file operating means exports the document file processed by the division process or the unification process on the palette window area into the list window area.

5. The document handling apparatus of claim 1, wherein the document file is able to output by an operation for the icon/thumbnail shown in the palette window.

6. The document handling apparatus of claim 1, wherein the document file on the palette window area is enable to receive an input operation.

7. The document handling apparatus of claim 1, wherein said file operating means creates a duplicated file of the document file being imported to the palette window area in accordance with the page division process.

8. A document handling apparatus for editing document file data comprising;
document file importing means, wherein said importing means creates new document file having a predetermined format on the basis of an import of an original document file; and
document file relating means for relating said created new document file with said original document file.

9. The document handling apparatus of claim 8, further comprising document file operating means for creating a duplicated file of said new document file and for dividing the duplicated file for each page.

10. The document handling apparatus of claim 8, wherein said predetermined format is a wide-used format for document.

11. The document handling apparatus of claim 8, wherein said predetermined format is PDF format.

12. The document handling apparatus of claim 8, wherein said document file relating means relates said created new document file with said original document file by storing both files in a predetermined directory.

13. The document handling apparatus of claim 8, wherein each document file is corresponding to file data stored in a memory, and at least one of said document file importing means and said document file relating means operates each document file on the basis of the file data in the memory.

14. A document handling apparatus for editing document file data comprising;
document file importing means for importing first document file;
document file creating means for creating second document file by converting first document file in a predetermined format;
editing means for executing a page division process and/or a page editing process for document files, wherein said editing means creates third document file duplicated from said second document file, and execute the page division process and/or the page editing process on the basis of said third document file; and
document relational means for relating said first document file with said second document file and for relating said second document file with third document file.

15. The document handling apparatus of claim 14, wherein said second document file is made by a wide-used format.

16. The document handling apparatus of claim 14, wherein said document relational means relates said first document file with said second document file by storing both files in a predetermined directory.

17. The document handling apparatus of claim 14, wherein each document file is corresponding to file data stored in a memory, and at least one of said document file importing means, said document file creating means, said editing means and said document relational means operates each document file on the basis of the file data in the memory.

18. The document handling apparatus of claim 14, further comprising window display means for displaying a list window area for lining up a plurality of icons/thumbnail for document files and a palette window area for editing the document file.

19. The document handling apparatus of claim 18, further comprising a display device, wherein said window display means displays said list window area and said palette window area through said display device.

20. The document handling apparatus of claim 18, wherein said editing means executes the page division process and/or the page editing process through an operation for the icon/thumbnail shown on said palette window area.

21. A computer readable medium including document handling program for editing document file data, said program comprising process of;
first window displaying process for displaying icon/thumbnails corresponding to a plurality of document files in a list window area;
importing process for importing at least one of said plurality of document files from the list window area to a palette window area;
second window displaying process for displaying icon/thumbnails corresponding to the document file being imported to the palette window area; and
file operating process for executing a procedure for a page division or a page unification for the document file on the basis of an operation of the icon/thumbnail shown on said palette window area.

22. The computer readable medium of claim 21, said program further comprising file exporting process for exporting document file processed by said procedure into the list window area.

23. The computer readable medium of claim 21, wherein the document file is able to output by an operation for the icon/thumbnail shown in the palette window.

24. The computer readable medium of claim 21, wherein the document file on the palette window area is able to receive an input operation.

25. A computer readable medium including document handling program for editing document file data, said program comprising process of;
creating process for creating a new document file having a predetermined format on the basis of an import of an original document file; and,
relating process for relating said created new document file with said original document file.

26. The computer readable medium of claim 25, wherein said predetermined format is a wide-used format for document.

27. The computer readable medium of claim 25, wherein said predetermined format is PDF format.

28. The computer readable medium of claim 25, wherein in said creating process said created new document file is shown as corresponding icon/thumbnail in a list window area.

29. The computer readable medium of claim 25, said program further comprising editing process for creating a duplicated file of said new document file, and for dividing the duplicated file for each page.

30. The computer readable medium of claim 29, said program further comprising showing process for showing icon/thumbnails corresponding to each divided page in a palette window area.

31. The computer readable medium of claim 25, wherein in said relating process, said created new document file is related with said original document file by storing both files in a predetermined directory.
